(19) United States
(12) Patent Application Publication
(10) Pub. No.: US 2008/0290044 A1
(43) Pub. Date: Nov. 27, 2008

(54) Chlorine Dioxide-Based Water Treatment System For On-Board Ship Applications

(76) Inventors: Chenniah Nanjundiah, San Diego, CA (US); Larry L. Hawn, Laguna Niguel, CA (US); Jeffrey M. Dotson, Fort Worth, TX (US)

Correspondence Address: MCANDREWS HELD & MALLOY, LTD, 500 WEST MADISON STREET, SUITE 3400, CHICAGO, IL, 60661, US

(21) Appl. No.: 12/109,296

(22) Filed: Apr. 24, 2008

Related U.S. Application Data
(63) Continuation of application No. PCT/US2006/060167, filed on Oct. 23, 2006.
(60) Provisional application No. 60/729,646, filed on Oct. 24, 2005.

(51) Int. Cl. C02F 1/467; C02F 1/28; C02F 1/36; C02F 1/46

(52) U.S. Cl. 210/748; 210/764; 210/198.1; 210/205; 210/195.1; 210/192; 210/96.1; 210/209

(57) ABSTRACT

An on-board ship water treatment system includes such features as drinking water purification and ballast water treatment. The on-board ship water treatment system includes an on-board ship water treatment vessel. A chlorine dioxide generator is fluidly connected to the on-board ship water treatment vessel. The chlorine dioxide generator includes a chlorine dioxide gas source and an absorption loop for effecting the dissolution of chlorine dioxide into a liquid stream. The absorption loop is fluidly connected to the chlorine dioxide gas source. A gas transfer assembly is interposed between the chlorine dioxide gas source and the absorption loop.

### CROSS-REFERENCE TO RELATED APPLICATION(S)

This application is a continuation of International Application No. PCT/US2006/060167, having an international filing date of Oct. 23, 2006, entitled “Chlorine Dioxide-Based Water Treatment System For On-Board Ship Applications”. International Application No. PCT/US2006/060167 claimed priority benefits, in turn, from U.S. Provisional Patent Application Ser. No. 60/729,646 filed Oct. 24, 2005. The '167 international application and the '646 provisional application are each hereby incorporated by reference herein in their entirety.

### FIELD OF THE INVENTION

The present invention relates generally to on-board ship water treatment. More particularly, the present invention relates to a chlorine dioxide generation system for use in water treatment onboard a ship, and is particularly suited to the amelioration of microorganisms in ballast water.

### BACKGROUND OF THE INVENTION

Water treatment is a significant concern in the shipping industry. Crews and passengers need water for personal use, such as drinking and bathing. However, it is uneconomical and inefficient to transport clean water for these purposes due to weight and space restraints on a ship. The water surrounding a ship can be used for these purposes but must be treated prior to human consumption or use.

Another important application for water treatment in the shipping industry relates to ballast water discharge. A common practice in the shipping industry is for ships to pump ballast water into holding tanks in order to balance the load on the ship. The ballast water is often pumped into the ship at one port, transported during the shipping process, and later discharged at a different port.

Ballast water transportation can contaminate coastal ecosystems and harbors. This contamination occurs when aquatic organisms and microorganisms from the first coastal ecosystem are transported to a foreign ecosystem and released. Scientists estimate that up to 3,000 alien species per day are transported in ballast water. The species that survive in the new ecosystem can cause natural disruptions to the ecosystem, which can lead to economic troubles and possible human disease.

In 1996, Congress responded to this problem by passing the National Invasive Species Act (NISA). Under NISA, the Secretary of Transportation developed regulations for ships entering U.S. waters. In order to comply with these regulations, ships must either undertake ballast exchange at high seas, which can be dangerous or impossible depending on weather conditions, or undergo decontamination measures.

Many attempts have been made to decontaminate ballast water. However, success has been limited. Many biocides do not effectively kill the wide variety of organisms found in ballast water. Other proposed methods harm the environment due to toxic byproducts. Yet other proposed methods are corrosive to ballast tanks or vessels.

A water treatment option for the shipping industry includes using chlorine dioxide (ClO₂). ClO₂ has many industrial and municipal uses. When produced and handled properly, ClO₂ is an effective and powerful biocide, disinfectant and oxidizer.

ClO₂ is used extensively in the pulp and paper industry as a bleaching agent, but is gaining further support in such areas as disinfections in municipal water treatment. Other end-uses can include as a disinfectant in the food and beverage industries, wastewater treatment, industrial water treatment, cleaning and disinfections of medical wastes, textile bleaching, odor control for the rendering industry, circuit board cleansing in the electronics industry, and uses in the oil and gas industry.

In water treatment applications, ClO₂ is primarily used as a disinfectant for surface waters with odor and taste problems. It is an effective biocide at low concentrations and over a wide pH range. ClO₂ is desirable because when it reacts with an organism in water, chlorite results, which studies to date have shown does not pose a significant adverse risk to human health at low concentrations. The use of chlorine, on the other hand, can result in the creation of chlorinated organic compounds when treating water. Such chlorinated organic compounds are suspected to increase cancer risk.

Producing ClO₂ gas for use in a ClO₂ water treatment process is desirable because there is greater assurance of ClO₂ purity when in the gas phase. ClO₂ is, however, unstable in the gas phase and will readily undergo decomposition into chlorine gas (Cl₂), oxygen gas (O₂) and heat. The high reactivity Of ClO₂ generally requires that it be produced and used at the same location. ClO₂ is, however, soluble and stable in an aqueous solution.

The production of ClO₂ can be accomplished both by electrochemical and reactor-based chemical methods. Electrochemical methods have an advantage of relatively safer operation compared to reactor-based chemical methods. In this regard, electrochemical methods employ only one precursor, namely, a chlorite solution, unlike the multiple precursors that are employed in reactor-based chemical methods. Moreover, in reactor-based chemical methods, the use of concentrated acids and chlorine gas poses a safety concern. Such safety concerns with reactor-based chemical methods is of even greater concern in the confined space of an on-board ship application. A further benefit of electrochemical production of ClO₂ is that the purity of the ClO₂ gas produced is higher than that of reactor-based chemical methods, which tends to have greater amounts of residual chemicals that detract from the ClO₂ gas purity (see, for example, G. Gordon, “Is All Chlorine Dioxide Created Equal?”, Journal of the Am. Water Works Assoc., Vol. 93, No. 4, April 2001, pp. 163-174; D. J. Gates, The Chlorine Dioxide Hand Book, Am. Water Works Assoc., 1998, p. 47).

Electrochemical cells are capable of carrying out selective oxidation reaction of chlorite to ClO₂. The selective oxidation reaction product is a solution containing ClO₂. To further purify the ClO₂ gas stream, the gas stream is separated from the solution using a stripper column. In the stripper column, air is passed from the bottom of the column to the top while the ClO₂ solution travels from top to the bottom. Pure ClO₂ is exchanged from solution to the air. Suction of air is usually accomplished using an eductor or a vacuum transfer pump, as described in U.S. Patent Application Publication No. 2006/0021872 entitled “Chlorine Dioxide Solution Generator”.

International Publication No. WO 2006/015071 entitled “Chlorine Dioxide Solution Generator” discloses different ways in which ClO₂ can be prepared such as through a reaction involving either chlorite (ClO₂⁻) or chlorate (ClO₃⁻) solutions. The ClO₂ created through such a reaction is often refined to generate ClO₂ gas for use in the water treatment process. The ClO₂ gas is then eventually transferred into the water selected for treatment.

It is known that ClO₂ is unstable and capable of decomposing, in which ClO₂ undergoes an exothermic reaction to form chlorine and oxygen. In fact, an operating temperature greater than about 163° F. (73° C.) can result in potentially hazardous and less efficient operation of the generator.

It would be desirable to have a reliable system and method for treating water on-board a ship. Moreover, it would be desirable to have a system and method that can effectively treat water on-board a ship while minimizing potential water treatment complications.

### SUMMARY OF THE INVENTION

An on-board ship water treatment system includes an onboard ship water treatment vessel with a chlorine dioxide generator fluidly connected to the water treatment vessel. The chlorine dioxide generator further includes a chlorine dioxide gas source and an absorption loop for effecting the dissolution of chlorine dioxide into a liquid stream. The absorption loop is fluidly connected to the chlorine dioxide gas source and a gas transfer assembly is interposed between the chlorine dioxide gas source and the absorption loop.

In a preferred on-board ship water treatment system, the chlorine dioxide gas source can include a single precursor chemical feed. In other preferred on-board ship water treatment systems, the water treatment vessel can be a container for drinking water or a ballast water tank. In another preferred on-board ship water treatment system, the chlorine dioxide generator can be mobile skid mounted.

In a preferred on-board ship water treatment system, the chlorine dioxide gas source can further includes an anolyte loop and a catholyte loop. The catholyte loop can be fluidly connected to the anolyte loop via a common electrochemical component. The anolyte loop can further include a reactant feedstock stream with at least one electrochemical cell fluidly connected to the said feedstock stream. The electrochemical cell can have a positive end and a negative end with the reactant feedstock stream directed through the electrochemical cell to produce a chlorine dioxide solution. The chlorine dioxide solution can be directed from the positive end of the electrochemical cell into a stripper column. The stripper column can produce at least one of a chlorine dioxide gas stream and excess chlorine dioxide solution. The excess chlorine dioxide solution can be directed out of the stripper column and recirculated with the reactant feedstock stream into the electrochemical cell. The chlorine dioxide gas stream can then exit the stripper column directed toward the absorption loop.

In a preferred on-board ship water treatment system, the reactant feedstock can be a chlorite solution. In another embodiment, the reactant feedstock can be a chlorate solution.

A preferred on-board ship water treatment system can further include a program logic control system. The program logic control system can further monitor the concentration of chlorine dioxide in the on-board ship water treatment vessel. In other embodiments, the program logic control system is capable of controlling the concentration of chlorine dioxide in the water treatment vessel.

In a preferred on-board ship water treatment system, the gas transfer assembly can further include a gas transfer pump having at least one inlet port for receiving a chlorine dioxide gas stream from the chlorine dioxide gas source and at least one outlet port for discharging a pressurized chlorine dioxide gas stream. The gas transfer pump further includes an exhaust manifold assembly extending from the gas transfer pump outlet port. The exhaust manifold assembly can include at least one manifold conduit defining an interior volume for directing the pressurized chlorine dioxide gas from the at least one gas transfer pump outlet port to the absorption loop. The manifold conduit interior volume is sufficiently large to inhibit chlorine dioxide decomposition in the pressurized chlorine dioxide gas stream.

In other preferred on-board ship water treatment systems, the manifold conduit interior volume is sufficiently large to induce a pressurized chlorine dioxide gas stream temperature within the manifold conduit of less than about 163° F. (73° C.). In other embodiments, the gas transfer pump can have first and second inlet ports for receiving first and second chlorine dioxide gas streams from the chlorine dioxide gas source. The gas transfer pump can have first and second outlet ports for discharging first and second pressurized chlorine dioxide gas streams. The discharge manifold assembly can also include first and second manifold conduits defining an aggregate conduit interior volume for directing the first and second pressurized chlorine dioxide gas streams, respectively, from the gas transfer pump to the absorption loop. The aggregate manifold conduit interior volume is sufficiently large to inhibit chlorine dioxide decomposition in the pressurized chlorine dioxide gas stream.

In other preferred on-board ship water treatment systems, the aggregate manifold conduit interior volume is sufficiently large to induce a pressurized chlorine dioxide gas stream temperature within the manifold conduit of less than about 163° F. (73° C.). In another embodiment, the first and second inlet ports can each have an inlet port conduit extending therefrom for receiving first and second chlorine dioxide gas streams from the chlorine dioxide gas source. The first and second outlet ports can each have an outlet port conduit extending therefrom for discharging first and second pressurized chlorine dioxide gas streams. The exhaust manifold assembly can include first and second manifold conduits defining an aggregate conduit interior volume for directing the first and second pressurized chlorine dioxide gas streams, respectively, from the gas transfer pump to the absorption loop. The aggregate manifold conduit interior volume is sufficiently large to inhibit chlorine dioxide decomposition in the pressurized chlorine dioxide gas stream.

In other preferred embodiments, the outlet port conduits are formed from a material having a melting point greater than about 140° F. (60° C.). In another embodiment, the outlet port conduits are formed from a material selected from the group consisting of polytetrafluoroethylene, polychlorotrifluoroethylene, chlorinated poly(vinyl chloride), titanium and other metals having a melting point greater than about 140° F. (60° C.).

In a preferred on-board ship water treatment system, the first and second inlet ports can each have an inlet port conduit extending therefrom for receiving first and second chlorine dioxide gas streams from the chlorine dioxide gas source. The first and second outlet ports can each have a pair of outlet port conduits extending therefrom for discharging two pairs of pressurized chlorine dioxide gas streams. The exhaust manifold assembly can include at least one manifold conduit defining an aggregate conduit interior volume for directing the first and second pressurized chlorine dioxide gas streams, respectively, from the gas transfer pump to the absorption loop. The aggregate manifold conduit interior volume is sufficiently large to inhibit chlorine dioxide decomposition in the pressurized chlorine dioxide gas stream.

In other preferred embodiments, the outlet port conduits are formed from a material having a melting point greater than about 140° F. (60° C.). In another embodiment, the outlet port conduits are formed from a material selected from the group consisting of polytetrafluoroethylene, polychlorotrifluoroethylene, chlorinated poly(vinyl chloride), titanium and other metals having a melting point greater than about 140° F. (60° C.). In another embodiment, the exhaust manifold assembly can include a single manifold conduit defining an interior volume for directing the two pairs of pressurized chlorine dioxide gas streams from the gas transfer pump to the absorption loop, wherein the interior volume is sufficiently large to inhibit chlorine dioxide decomposition in said pressurized chlorine dioxide gas stream.

In a preferred on-board ship water treatment system, the ratio of the cross-sectional diameter of the manifold conduit to the cross-sectional diameter of the gas transfer pump outlet port is greater than 1. In other preferred embodiments, the exhaust manifold assembly has a coolant fluid stream in thermal contact therewith, whereby the coolant fluid stream further inhibits chlorine dioxide decomposition in the pressurized chlorine dioxide gas stream. In another embodiment, the coolant fluid stream is in thermal contact with the manifold conduit. In another embodiment, the thermal contact of the coolant fluid stream with the manifold conduit further induces a pressurized chlorine dioxide gas stream temperature within the manifold conduit of less than about 163° F. (73° C.).

A preferred method of treating water on-board a ship includes providing a source of chlorine dioxide gas, effecting the dissolution of chorine dioxide into a liquid stream by employing an absorption loop fluidly connected to the chlorine dioxide gas source and introducing the chlorine dioxide solution into a ballast water supply.

In a preferred method of treating water on-board a ship, the introduction of the chlorine dioxide solution into a ballast water supply occurs prior to loading the ship, during the ship's voyage, or during discharge of the ballast water from the ship. In other preferred methods, the introduction of the chlorine dioxide solution into a ballast water supply can occur through a hydrophobic, microporous membrane to a recipient medium. In another embodiment, the method further includes exposing the ballast water to intense, low frequency sonic energy. In another embodiment, the method includes introducing additional biocide into the ballast water.

A preferred method of treating water on-board a ship includes interposing a gas transfer pump between the chlorine dioxide gas source and the absorption loop. The gas transfer pump can have at least one inlet port for receiving a chlorine dioxide gas stream from the chlorine dioxide gas source and at least one outlet port for discharging a pressurized chlorine dioxide gas stream. The method further includes interposing an exhaust manifold assembly between the gas transfer pump outlet port and the absorption loop. The exhaust manifold assembly includes at least one manifold conduit defining an interior volume for directing the pressurized chlorine dioxide gas stream from the gas transfer pump outlet port to the absorption loop. The method further includes inhibiting chlorine dioxide decomposition in the pressurized chlorine dioxide gas stream by effecting a volumetric increase between the gas transfer pump outlet port and the manifold conduit. In another preferred embodiment, the volumetric increase in the method induces a pressurized chlorine dioxide gas stream temperature within the at least one manifold conduit of less than about 163° F. (73° C.).

### BRIEF DESCRIPTION OF THE DRAWING(S)

FIG. 1 illustrates an embodiment of a process flow diagram of a ClO₂ solution generator.

FIG. 2 illustrates an embodiment of a process flow diagram of an anolyte loop of a ClO₂ solution generator.

FIG. 3 illustrates an embodiment of a process flow diagram of a catholyte loop of a ClO₂ solution generator.

FIG. 4 illustrates an embodiment of a process flow diagram of an absorption loop of a ClO₂ solution generator.

FIG. 5a is a top view of an embodiment of a ClO₂ gas stream pump configuration in a ClO₂ solution generator.

FIG. 5b is a top view of an embodiment of a ClO₂ gas stream pump configuration for a ClO₂ solution generator having temperature control capability.

FIG. 5c is a top view of another embodiment of a ClO₂ gas stream pump configuration for a ClO₂ solution generator having temperature control capability.

FIG. 6 is a top view of an embodiment of a ClO₂ gas stream pump configuration for a ClO₂ solution generator having temperature control capability, similar to the embodiment illustrated in FIG. 5b, but in which a water stream is mixed with the ClO₂ stream to further control the temperature of the ClO₂ stream before introducing the mixed stream to the absorption loop

FIG. 7 illustrates a cross section of a ship showing ballast tank placements.

FIG. 8 illustrates an embodiment of a process flow diagram of a ClO₂ solution generator for use in a water treatment system for on-board ship applications.

FIG. 9 illustrates an embodiment of a process flow diagram of the ClO₂ solution generator program logic control system.

### DETAILED DESCRIPTION OF PREFERRED EMBODIMENT(S)

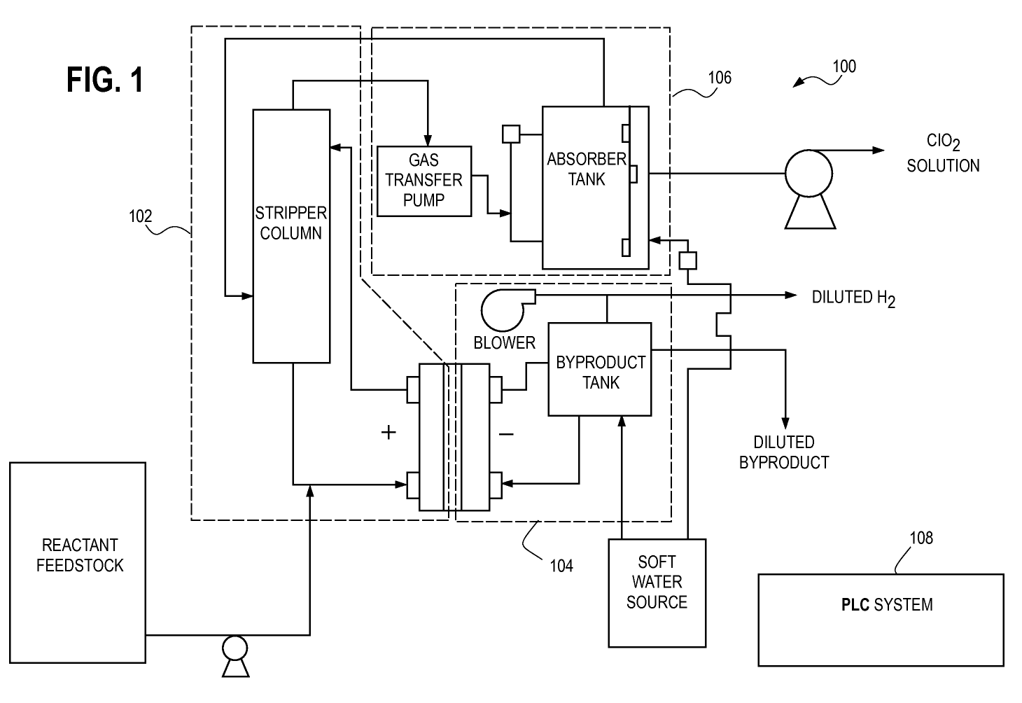

FIG. 1 illustrates a process flow diagram of an embodiment of chlorine dioxide solution generator 100 having the aspects disclosed herein and the aspects demonstrated in International Publication No. WO 2006/015071 entitled “Chlorine Dioxide Solution Generator”. The process flow of FIG. 1 consists of three sub-processes including an anolyte loop 102, a catholyte loop 104 and an absorption loop 106. The anolyte loop 102 can produce a ClO₂ gas by oxidation of chlorite, and the process in combination with catholyte loop 104 can more generally be referred to as a ClO₂ gas generator loop. The ClO₂ gas generator loop is essentially a ClO₂ gas source. Various sources of ClO₂ are available and known in the water treatment field. Catholyte loop 104 of the ClO₂ gas generator loop produces sodium hydroxide and hydrogen gas by reduction of water. Once the ClO₂ gas is produced in the ClO₂ gas generator loop, the ClO₂ gas is transferred to absorption loop 106 where the gas is further conditioned for water treatment end-uses. The process can be operated through a program logic control (PLC) system 108 that can include visual and/or audible displays.

In this application, the term “absorb” refers to the process of dissolving or infusing a gaseous constituent into a liquid, optionally using pressure to effect the dissolution or infusion. Here, ClO₂ gas, which is produced in the ClO₂ gas generator loop, is “absorbed” (that is, dissolved or infused) into an aqueous liquid stream directed through absorption loop 106.

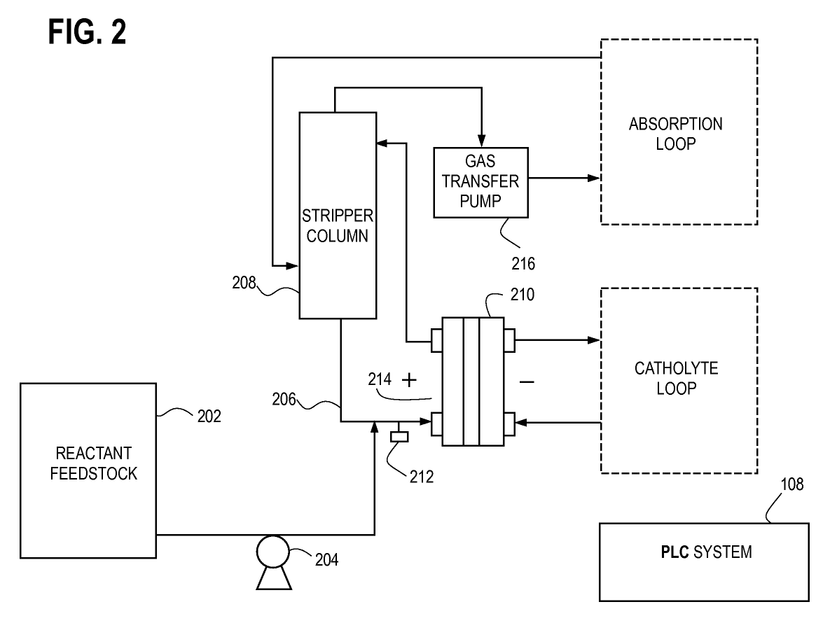

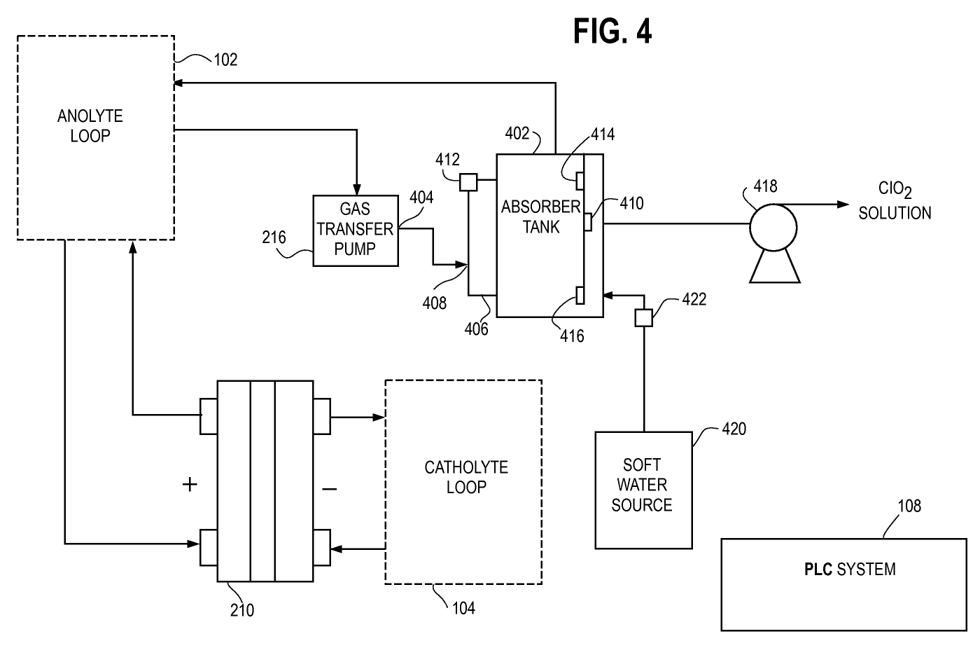

FIG. 2 illustrates an anolyte loop 102 (see FIG. 1 and FIG. 4) in an embodiment of chlorine dioxide solution generator 100 (see FIG. 1) having the aspects disclosed herein and the aspects demonstrated in International Publication No. WO 2006/015071 entitled “Chlorine Dioxide Solution Generator”. The contribution of anolyte loop 102 to the ClO₂ solution generator is to produce a ClO₂ gas that is directed to absorption loop 106 for further processing. The anolyte loop 102 embodiment illustrated in FIG. 2 is for producing a ClO₂ gas using a reactant feedstock 202. In a preferred embodiment, a 25 percent by weight sodium chlorite (NaClO₂) solution can be used as reactant feedstock 202. However, feedstock concentrations ranging from 0 percent to a maximum solubility (40 percent at 17° C. in the embodiment involving NaClO₂), or other suitable method of injecting suitable electrolytes, can be employed.

The reactant feedstock 202 can be connected to a chemical metering pump 204, which delivers the reactant feedstock 202 to a recirculating connection 206 in the anolyte loop 102. Recirculating connection 206 in anolyte loop connects a stripper column 208 to an electrochemical cell 210. The delivery of the reactant feedstock 202 can be controlled using PLC system 108. PLC system 108 can be used to activate chemical metering pump 204 according to signals received from a pH sensor 212. pH sensor 212 is generally located along recirculating connection 206. A pH set point can be established in PLC system 108, and once the set point is reached, the delivery of reactant feedstock 202 can either start or stop.

Reactant feedstock 202 can be delivered to a positive end 214 of electrochemical cell 210 where the reactant feedstock is oxidized to form a ClO₂ gas, which is then dissolved in an electrolyte solution along with other side products. The ClO₂ solution with the side products is directed away from electrochemical cell 210 to the top of stripper column 208 where a pure ClO₂ is stripped off in a gaseous form from the other side products. Side products or byproducts can include chlorine, chlorates, chlorites and/or oxygen. The pure ClO₂ gas is then removed from stripper column 208 under a vacuum induced by gas transfer pump 216, or analogous gas or fluid transfer device (such as, for example, other vacuum-based devices), where it is delivered to adsorption loop 106. The remaining solution is collected at the base of stripper column 208 and recirculated back across the pH sensor 212 where additional reactant feedstock 202 can be added. The process with the reactant feedstock and/or recirculation solution being delivered into positive end 214 of electrochemical cell 210 can then be repeated.

Modifications to the anolyte loop process can be made that achieve similar results to the embodiments described herein. As an example, an anolyte hold tank can be used in place of a stripper column. In such a case, an inert gas or air can be blown over the surface or through the solution to separate the ClO₂ gas from the anolyte. As another example, chlorate can be reduced to produce ClO₂ in a catholyte loop instead of chlorite. The ClO₂ gas would then similarly be transferred to the absorption loop 106. In a further example, ClO₂ can be generated by purely chemical generators and transferred to an absorption loop 106 for further processing.

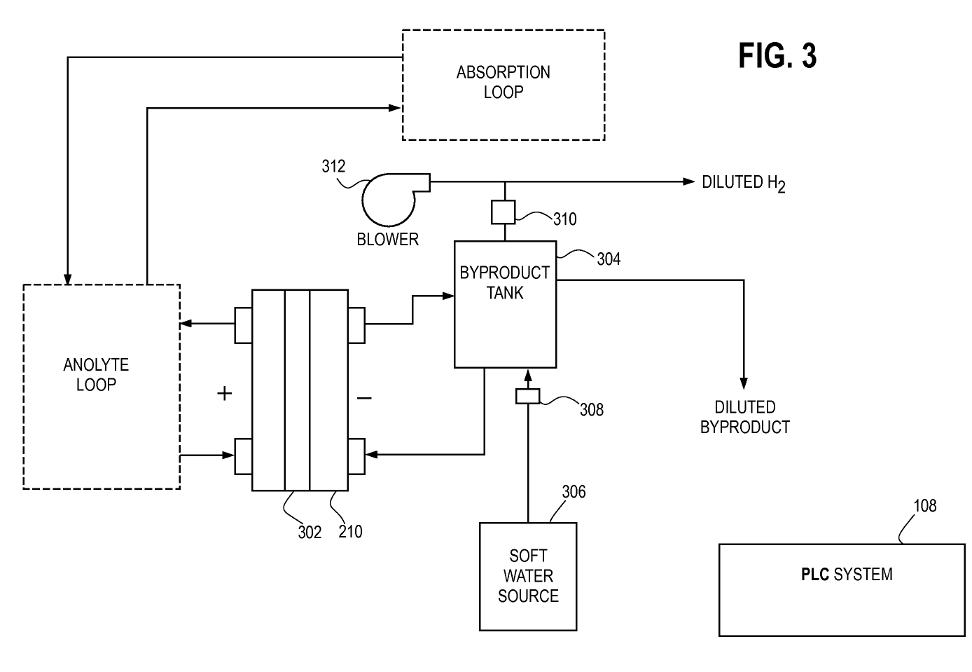

FIG. 3 illustrates a catholyte loop 104 (see FIG. 1 and FIG. 4) in an embodiment of a chlorine dioxide solution generator 100 having the aspects disclosed herein and the aspects demonstrated in International Publication No. WO 2006/015071 entitled “Chlorine Dioxide Solution Generator”. Catholyte loop 104 contributes to the chlorine dioxide solution generator 100 (see FIG. 1) by handling byproducts produced from the electrochemical reaction of reactant feedstock 202 (see FIG. 2) solution in anolyte loop 102 (see FIG. 1 and FIG. 4). As an example, where a sodium chlorite (NaClO₂) solution is used as reactant feedstock 202, sodium ions from the anolyte loop 102 migrate to catholyte loop 104 through a cationic membrane 302, in electrochemical cell 210, to maintain charge neutrality. Water in the catholyte is reduced to produce hydroxide and hydrogen (H₂) gas. The resulting byproducts in catholyte loop 104, in the example of an NaClO₂ reactant feedstock, are sodium hydroxide (NaOH) and H₂ gas. The byproducts can be directed to a byproduct tank 304.

In an embodiment of catholyte loop 104, in the example of a NaClO₂ reactant feedstock, a soft (that is, demineralized) water source 306 can be used to dilute the byproduct NaOH using a solenoid valve 308 connected between soft water source 306 and the byproduct tank 304. Solenoid valve 308 can be controlled with PLC system 108. In a preferred embodiment, PLC system 108 can use a timing routine that maintains the NaOH concentration in a range of 5 percent to 20 percent. When byproduct tank 304 reaches a predetermined level above the base of byproduct tank 304, the diluted NaOH byproduct above that level is removed from catholyte loop 104.

In the example of a NaClO₂ reactant feedstock, catholyte loop 104 self circulates using the lifting properties of the H₂ byproduct gas formed during the electrochemical process and forced water feed from soft water source 306. The H₂ gas rises up in byproduct tank 304 where there is a hydrogen disengager 310. The H₂ gas can be diluted with air in hydrogen disengager 310 to a concentration of less than 0.5 percent. The diluted H₂ gas can be discharged from catholyte loop 104 of the chlorine dioxide solution generator 100 using a blower 312.

In another embodiment, dilute sodium hydroxide can be fed to the byproduct tank 304, instead of water, to produce concentrated sodium hydroxide. Oxygen or air can also be used as a reductant instead of water to reduce overall operation voltage since oxygen reduces at lower voltage than water.

The reaction of anolyte loop 102 and catholyte loop 104 in the embodiments illustrated in FIGS. 2 and 3 is represented by the following net chemical equation.

2NaClO_{2(aq)}+2H₂O→2ClO_{2(gas)}+2NaOH_{(aq)}+H_{2(gas)}

NaClO₂ can be provided by reactant feedstock 202 of anolyte loop 102. NaOH and H₂ gas are byproducts of the reaction in catholyte loop 104. The ClO₂ solution along with the remaining unreacted NaClO₂ and other side products are directed to the stripper column for separation into ClO₂ gas as part of the anolyte loop 102 process. Chlorite salts other than NaClO₂ can be used in anolyte loop 102.

FIG. 4 illustrates an absorption loop 106 (see FIG. 1) of an embodiment of a chlorine dioxide solution generator 100 (see FIG. 1) having the aspects disclosed herein and the aspects demonstrated in International Publication No. WO 2006/015071 entitled “Chlorine Dioxide Solution Generator”. Absorption loop 106 processes the ClO₂ gas from anolyte loop 102 into a ClO₂ solution that is ready to be directed to the water selected for treatment.

ClO₂ gas is removed from stripper column 208 (see FIG. 2) of anolyte loop 102 using gas transfer pump 216. In a preferred embodiment, a gas transfer pump 216 can be used that is “V” rated at 75 Torr (10 kPa) with a discharge rate of 34 liters per minute. The vacuum and delivery rate of gas transfer pump 216 can vary depending upon the free space in stripper column 208 and desired delivery rate of ClO₂ solution.

The ClO₂ gas removed from stripper column 208 using gas transfer pump 216 is directed to an absorber tank 402 of absorption loop 106. In a preferred embodiment, discharge side 404 of gas transfer pump 216 delivers ClO₂ gas into a 0.5-inch (13-mm) poly(vinyl chloride) (PVC) injection line 406 external to absorber tank 402. Injection line 406 is an external bypass for fluid between the lower to the upper portions of the absorption tank 402. A gas injection line can be connected to injection line 406 using a T-connection 408. Before ClO₂ gas is directed to absorber tank 402, the tank 402 is filled with water to approximately 0.5 inch (13 mm) below a main level control 410. Main level control 410 can be located below where injection line 406 connects to the upper portion of absorption tank 402. Introducing ClO₂ gas into injection line 406 can cause a liquid lift that pushes newly absorbed ClO₂ solution up past a forward-only flow switch 412 and into absorber tank 402. Flow switch 412 controls the amount of liquid delivered to absorber tank 402. Absorber tank 402 has a main control level 410 to maintain a proper tank level. In addition to main control level 410, safety control levels can be employed to maintain a high level 414 and low level 416 of liquid where main control level 410 fails. A process delivery pump 418 can feed ClO₂ solution from absorption tank 402 to the end process without including air or other gases. Process delivery pump 418 is sized to deliver a desired amount of water per minute. The amount Of ClO₂ gas delivered to absorber tank 402 is set by the vacuum and delivery rate set by gas transfer pump 216.

PLC system 108 can provide a visual interface for the operator to operate the chlorine dioxide solution generator 100. For example, PLC system 108 can automatically control the continuous operation and safety of the production of ClO₂ solution. PLC system 108 can set flow rates for anolyte loop 102 and catholyte loop 104. The safety levels of absorber tank 402 can also be enforced by PLC system 108. PLC system 108 can also control the power used to achieve a desired current for an embodiment using an electrochemical cell 210. In a preferred embodiment, the current can range from 0 to 100 amperes, although currents higher than this range are possible. The amount of current determines the amount Of ClO₂ gas that is produced in anolyte loop 102. The current of the power supply can be determined by the amount of ClO₂ that is to be produced. PLC system 108 can also be used to monitor the voltage of electrochemical cell 210. In a preferred embodiment, electrochemical cell 210 can be shut down when the voltage exceeds a safe voltage level. In another preferred embodiment, 5 volts can be considered a safe voltage level.

In another embodiment, the temperature of electrochemical cell 210 can be monitored with PLC system 108. If overheating occurs, PLC system 108 can shut down electrochemical cell 210. PLC system 108 can also monitor the pH of the anolyte using a pH sensor 212 (shown in FIG. 2). During operation of electrochemical cell 210, the pH of the solution circulating in anolyte loop 102 decreases as hydrogen ions are generated. In the exemplary embodiment of the NaClO₂ reactant feedstock, when the pH goes below 5, additional reactant feedstock can be added using PLC system 108. Control of pH can also be handled by adding a reactant that decreases pH when pH is considered to be too high.

In another embodiment, the transfer line from gas transfer pump 216 can be connected to absorber tank 402 directly without injection line 406, and can allow for increasing the transfer rate of the pump. Other embodiments can include a different method of monitoring the liquid level in absorber tank 402. For example, an oxidation and reduction potential (ORP) can be dipped in absorber tank 402. ORP can be used to monitor the concentration Of ClO₂ in the solution in absorber tank 402. PLC system 108 can be used to set a concentration level for the ClO₂ as monitored by ORP, which provides an equivalent method of controlling the liquid level in absorber tank 402. Optical techniques such as photometers can also be used to control the liquid level in absorber tank 402. In other embodiments, absorption loop 106 can be a part of the chlorine dioxide solution generator or it can be installed as a separate unit outside of the chlorine dioxide solution generator. In another embodiment, process water can be fed directly in absorber tank 402 and treated water can be removed from the absorber tank 402. The process water can include a demineralized, or soft, water source 420 and the process water feed can be controlled using a solenoid valve 422.

The process flow illustrated in FIGS. 1, 2 and 3 are based on ClO₂ gas produced using a preferred embodiment of electrochemical cells and sodium chlorite reactant feedstock solution. ClO₂ gas can be made using many different processes that would be familiar to a person skilled in water treatment technologies. Such processes include, but are not limited to, acidification of chlorite, reduction of chlorates by acidification, reduction of chlorates by acidification and the reduction of chlorates by sulfur dioxide.

Among other parameters, the material, the diameter, as well as the relative configuration and arrangement of the conduits (or pipes or tubes) associated with the present chlorine dioxide solution generator are important for safe, efficient and reliable operation of the generator. In particular, the ClO₂ gas stream should be removed from the generator at a temperature no greater than about 163° F. (73° C.), depending upon the diameter of the conduit or tube through which the ClO₂ gas stream is carried.

As previously stated, it is known that ClO₂ at a temperature greater than about 163° F. (73° C.) can decompose to form chlorine and oxygen. Such decomposition is typically accompanied by an increase in the temperature of the ClO₂ stream, with temperatures as high 280° F. (138° C.), which is greater than the melting temperature of both PVC and CPVC (chlorinated polyvinyl chloride)). PVC and CPVC are the typical materials from which the fluid stream conduits or pipes employed in chlorine dioxide solution generators, and the melting of those conduits can create hazardous operating conditions. It is therefore important to reduce and maintain the temperature of the chloride dioxide stream exiting the generator as low as possible.

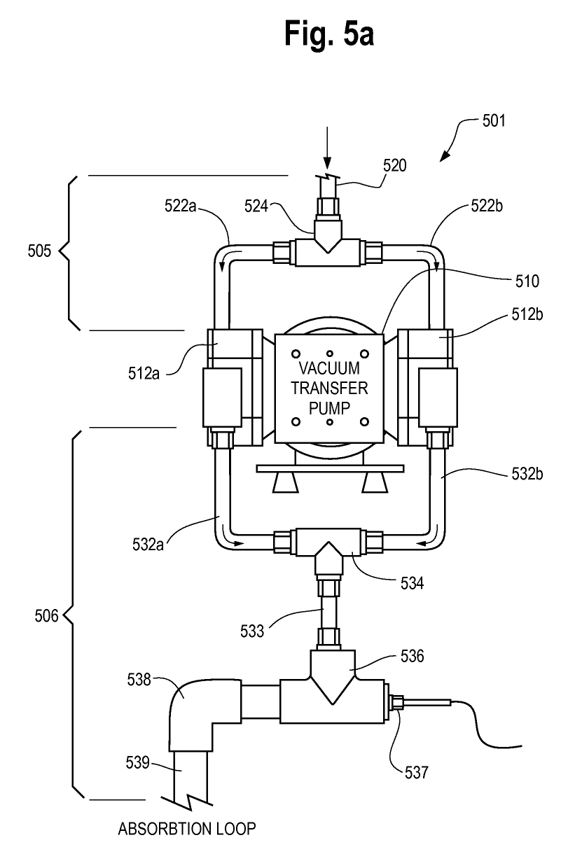

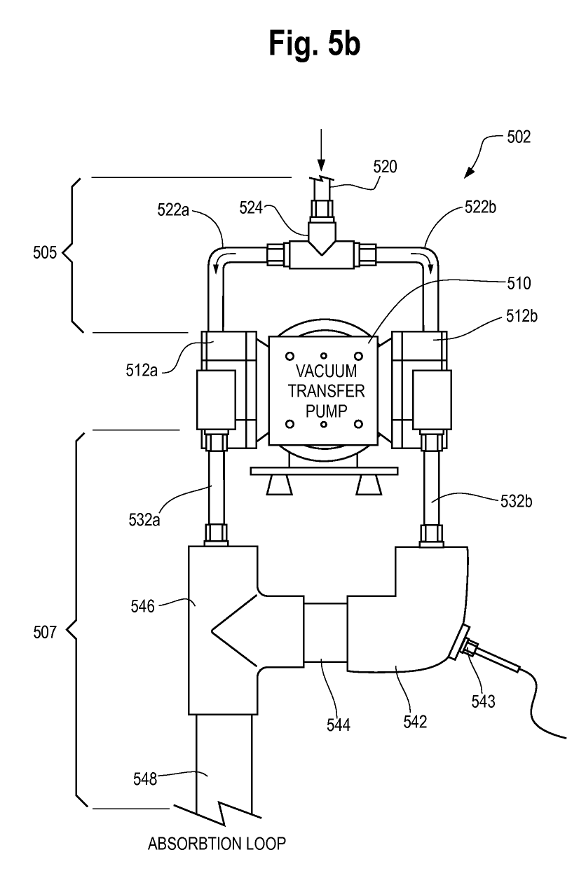

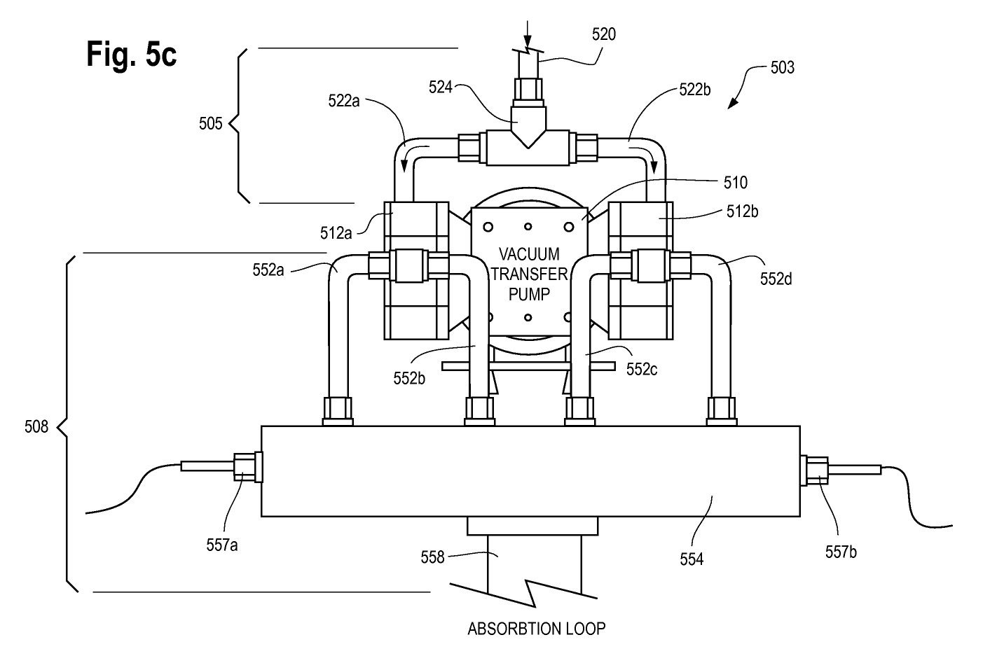

FIG. 5a shows an embodiment of a ClO₂ gas stream pump configuration 501 for a ClO₂ solution generator. Pump configuration 501 is interposed between a ClO₂ gas source of the type illustrated in FIGS. 1 and 2, and an absorption loop of the type illustrated in FIGS. 1 and 4.

Pump configuration 501 includes a gas transfer pump 510 interposed between an inlet manifold assembly 505 and an exhaust manifold assembly 506. Gas transfer pump 510 can have two head portions 512a and 512b, which produce a pressurized gas stream from an incoming gas stream. A ClO₂ gas stream from a ClO₂ gas source (not shown) is directed to pump 510 via conduit 520, which branches at T-connector 524 to a pair of inlet conduits 522a, 522b. The ClO₂ gas stream in inlet conduit 512a is fed to pump head 512a, where the stream is pressurized and discharged from pump head 512a via outlet conduit 532a. Similarly, the ClO₂ gas stream in inlet conduit 512b is fed to pump head 512b, where the stream is pressurized and discharged from pump head 512b via outlet conduit 532b. The pressurized ClO₂ gas streams directed through outlet conduits 532a, 532b can then be combined into one stream at T-connector 534, and the combined stream can then be directed through conduit 533 to a fitting 536, in which a thermocouple 537 can be mounted and from which the combined stream can be directed to the absorption loop (not shown) via conduit 539 and intermediate pipe connections and fittings, one of which is illustrated in FIG. 5a as elbow fitting 538.

FIG. 5b shows an embodiment of a ClO₂ gas stream pump configuration 502, aspects of which are also described in International Publication No. WO 2006/015071 entitled “Chlorine Dioxide Solution Generator”, for a ClO₂ generator having temperature control capability. As with pump configuration 501 in FIG. 5 a, pump configuration 502 is interposed between a ClO₂ gas source of the type illustrated in FIGS. 1 and 2, and an absorption loop of the type illustrated in FIGS. 1 and 4.

Pump configuration 502 includes gas transfer pump 510, an inlet manifold assembly 505, which as illustrated in FIG. 5b is essentially identical to the inlet manifold assembly shown in FIG. 5a. Pump configuration 502 also includes an exhaust manifold assembly 507, in which the inlet streams are pressurized and discharged from pump heads 512a, 512b via outlet conduits 532a, 532b, respectively. The pressurized ClO₂ gas streams directed through outlet conduits 532a, 532b are separately directed to conduits in which the pressurized streams undergo volumetric expansion. Thus, the pressurized ClO₂ gas stream in outlet conduit 532a is directed to and expanded within a T-connector 546, and the pressurized ClO₂ gas stream in outlet conduit 532b is directed to an elbow fitting 542, in which a thermocouple 537 is mounted and from which the stream is directed through conduit 544. The stream directed through conduit 544 is combined with the other pressurized and expanded ClO₂ gas stream at T-connector 546, and the combined stream is then directed from T-connector 546 to the downstream absorption loop via conduit 548 (and intermediate pipe connections and fittings, if any (not shown in FIG. 5b)).

FIG. 5c shows an embodiment of a ClO₂ gas stream pump configuration 503 for a ClO₂ solution generator having temperature control capability. As with pump configuration 501 in FIG. 5a and pump configuration 502 in FIG. 5b, pump configuration 503 is interposed between a ClO₂ gas source of the type illustrated in FIGS. 1 and 2, and an absorption loop of the type illustrated in FIGS. 1 and 4.

Pump configuration 503 includes gas transfer pump 510, an inlet manifold assembly 505, which as illustrated in FIG. 5c is essentially identical to the inlet manifold assembly shown in FIGS. 5a and 5b. Pump configuration 503 also includes an exhaust manifold assembly 508, in which the inlet streams are pressurized and discharged from pump head 512a via outlet conduits 552a, 552b and from pump head 512b via outlet conduits 552c, 552d. The pressurized ClO₂ gas streams directed through outlet conduits 552a, 552b, 552c, 552d are separately directed to a single conduit 554, in which the pressurized streams are combined and undergo volumetric expansion. The stream directed through conduit 554 is then directed to the downstream absorption loop (not shown) via conduit 558 (and intermediate pipe connections and fittings, if any). Thermocouples 557a, 557b are mounted on opposite ends of conduit 544.

In a preferred embodiment, the ClO₂ gas stream exiting the pump orifice in FIGS. 5a, 5b and 5c, which has a diameter of 0.25 inch (0.64 cm) can be cooled by expanding the volume of the gas stream. The extent of expansion should be such that the induction period for decomposition of ClO₂ at the temperature and pressure indicated is greater than 20 seconds. According to published graphs in the technical literature (see, for example, Loss Prevention Bulletin, I. Chem. E. 113, October 1993 by G. Cowley), the temperature and induction period for 5 percent by volume Of ClO₂ in air (corresponds to a partial pressure of 38 mm of Hg) is shown below in Table 1.

TABLE 1
Induction period to decomposition of ClO2 (5% by
volume in air) at a partial pressure of 38 mm Hg

| Temperature | Induction period |
|---|---|
| (° F./° C.) | (minutes) |
| 163/73 | 0.33 |
| 124/51 | 60 |
| 106/41 | 400 |

In the chlorine dioxide solution generator with temperature control capability aspects of which are described herein and further described in International Publication No. WO 2006/015071 entitled “Chlorine Dioxide Solution Generator”, the ClO₂ temperature is preferably reduced to and maintained at below 163° F. (73° C.). This can be accomplished in several ways, as illustrated with reference to the embodiments of FIGS. 5a, 5b and 5c. The temperatures of the pressurized ClO₂ gas streams were measured at thermocouple 537 (in the embodiment of FIG. 5a), at thermocouple 543 (in the embodiment of FIG. 5b), and at thermocouple 557b (in the embodiment of FIG. 5c). The operating data is shown in Table 2 below:

TABLE 2
Temperature of ClO₂ for various nominal diameters of the conduits depicted in FIGS. 5a, 5b and 5c

| | Conduit | | | | | | | | |
|---|---|---|---|---|---|---|---|---|---|
| | 532a | 532b | 532c | 532d | 533 | 539 | 544 | 554 | Temp |
| FIG. | (in/cm) | (in/cm) | (in/cm) | (in/cm) | (in/cm) | (in/cm) | (in/cm) | (in/cm) | (° F./° C.) |
| 5a | 0.50/1.27 | 0.50/1.27 | — | — | 0.50/1.27 | 1.00/2.54 | — | — | >280/>138 |
| 5b | 0.50/1.27 | 0.50/1.27 | — | — | — | — | 1.00/2.54 | — | 162/72 |
| 5b | 0.75/1.91 | 0.75/1.91 | — | — | — | — | 2.00/5.08 | — | 153/67 |
| 5b | 0.75/1.91 | 0.75/1.91 | — | — | — | — | 1.00/2.54 | — | 151/66 |
| 5c | 0.50/1.27 | 0.50/1.27 | 0.50/1.27 | 0.50/1.27 | — | — | — | 2.00/5.08 | 153/67 |

The data in Table 2 show that increasing the diameter of the conduit carrying the ClO₂ stream induces a reduction in the temperature of the stream.

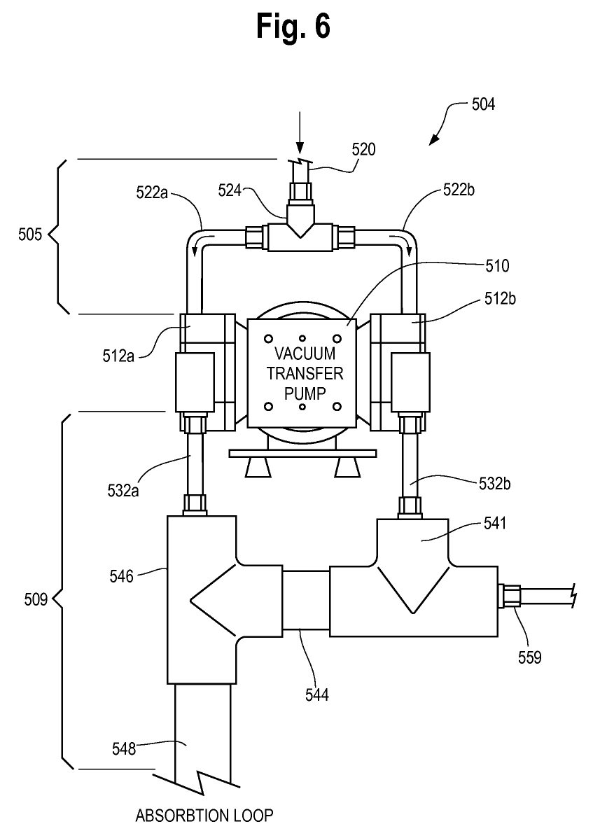

Another way of reducing the temperature of the ClO₂ stream is to introduce water at the conduit, such as, for example, the conduit formed in T-connector 541 shown in FIG. 6, in which a water stream is mixed with the ClO₂ stream to control the temperature of the ClO₂ stream before introducing the mixed stream to the vacuum gas transfer pump.

In a preferred embodiment, as the current in the electrochemical cell is increased, the concentration Of ClO₂ in the absorber tank of the absorption loop 106 increases as shown in Table 3 below:

TABLE 3
Increased ClO₂ Production With Increased Current

| Current | Concentration of ClO₂ (ppm) in the | Pounds Per |
|---|---|---|
| (ampere) | Absorber Tank Based On 1-gpm of Water | Day |
| 10 | 317 | 4 |
| 20 | 635 | 8 |
| 40 | 1270 | 18 |
| 60 | 1904 | 24 |
| 80 | 2540 | 32 |
| 100 | 3174 | 40 |

FIG. 6 shows a ClO₂ gas stream pump configuration 504 for a chlorine dioxide solution generator having temperature control capability, which is similar to the embodiment illustrated in FIG. 5b, but in which a water stream directed through conduit 559 is mixed with a pressurized ClO₂ gas stream to control the temperature of the ClO₂ stream(s) before introducing the mixed stream(s) to the absorption loop.

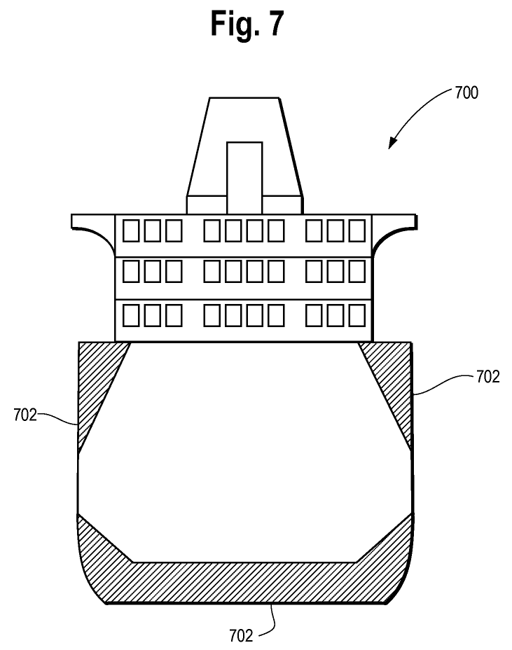

FIG. 7 illustrates a cross section of a ship 700 showing potential locations for ballast tanks 702. The ballast tanks 702 take in and hold as much water as is required to stabilize the ship 700 during its voyage. Organisms can live inside ballast tank 702 during the voyage and the extent of organism activity can depend on the source of the water stored in ballast tank 702. A chlorine dioxide solution generator 100 can be incorporated with the ballast tanks 702 to control organism activity in the water stored in ballast tanks 702.

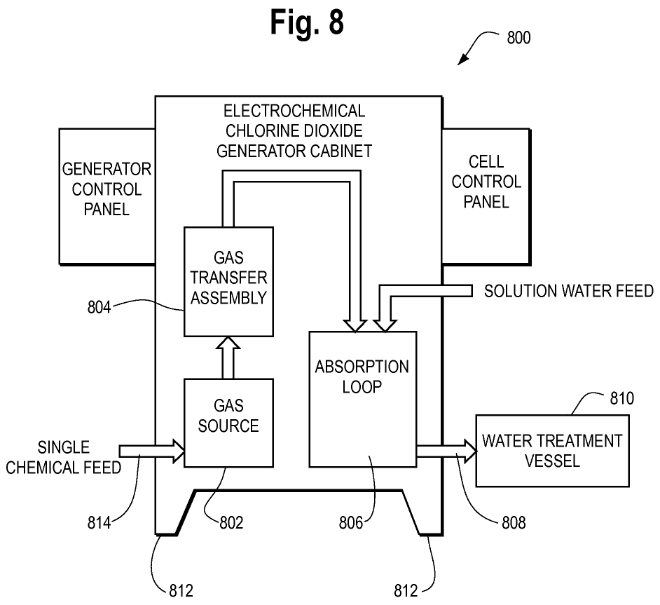

FIG. 8 illustrates a chlorine dioxide solution generator 800 of the type described herein for use on-board a ship. The chlorine dioxide solution generator has a chlorine dioxide gas source 802 fluidly connected to an absorption loop 806 with a gas transfer assembly 804 interposed between the two. The absorption loop has an outlet 808 for chlorine dioxide solution, which is fluidly connected, to a water treatment vessel 810 for treatment of water such as ballast water, drinking water, or other water treatment needs on-board a ship. In a preferred embodiment, the chlorine dioxide solution generator 800 can have an inlet 814 for a single chemical feed, such as a chlorite reactant feedstock.

In order to kill organisms in the water treatment vessel 810 a chlorine dioxide solution is introduced into the water. In the case of treating water in a ballast tank, the chlorine dioxide solution can be introduced prior to loading the ship, during the ship's voyage or during discharge of the ballast water.

The chlorine dioxide solution generator 800 can have many of the elements described for FIGS. 1-6. In further embodiments, the chlorine dioxide solution generator 800 can be skid-mounted 812 for quick and easy installment on-board a ship. In a skid mount, the chlorine dioxide solution generator 800 can be completely assembled on object(s) that form a base, such as planks or beams that support and elevate the structure. The chlorine dioxide solution generator can then be readily placed on-board the ship.

In another embodiment, additional purification can be obtained using a hydrophobic, microporous gas membrane positioned at outlet 808. An example of such a gas membrane that can be used for additional purification is described in International Publication No. WO 94/26670 entitled “Chlorine Dioxide Generation for Water Treatment”. The difference in the partial pressure of chlorine dioxide on the two sides of the gas membrane causes chlorine dioxide to be transferred from the chlorine dioxide solution into the water treatment vessel 810 by gaseous phase transfer through the membrane so as to treat the water in water treatment vessel 810.

The chorine dioxide treatment of ballast water can also be carried out in conjunction with other water treatment techniques. Examples of other treatment techniques include, but are not limited to, the use of other biocides and/or treatment with intense, low frequency sonic energy or other thermal treatment methods, as used for instance, to treat zebra mussel migration.

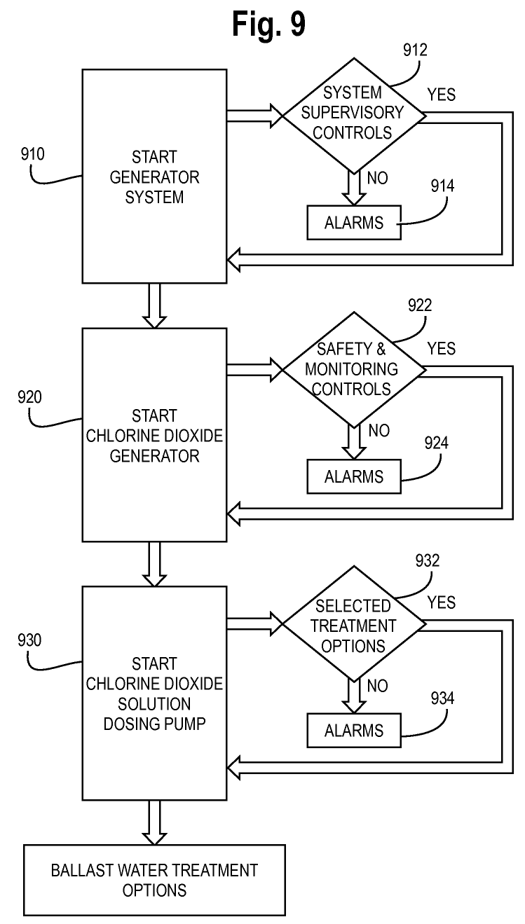

FIG. 9 shows a process flow diagram of the chlorine dioxide generator program logic control system. A program logic control (PLC) system can be used to control the water treatment system. The PLC system can monitor the concentration of ClO₂ in the solution and control the level accordingly. This can be done by dipping an oxidation and reduction potential (ORP) device into the tank or vessel to be monitored. ORP can monitor the concentration of ClO₂ in the solution. PLC system can be used to set a concentration level for the ClO₂ as monitored by ORP, which provides an equivalent method of controlling the ClO₂ level.

For example, the PLC system can be used to start a generator system 910, start a chlorine dioxide generator 920 and/or to start a chlorine dioxide solution dosing pump 930 based on certain ballast water treatment options. A loop for the start generator system 910 task can include system supervisory controls 912 that can trigger an alarm 914 depending on the generator system status. A loop for the start chlorine dioxide generator 920 task can include safety and monitoring controls 922 that can trigger an alarm 924 depending on the status of the control points in the chlorine dioxide gas source. A loop for the start chlorine dioxide solution dosing pump 930 task can include selected treatment options 932 that can trigger an alarm 934 depending on the status of the selected treatment options using the dosing pump.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. An on-board ship water treatment system comprising:
(a) an on-board ship water treatment vessel; and
(b) a chlorine dioxide generator fluidly connected to said on-board ship water treatment vessel, said chlorine dioxide generator comprising;
(i) a chlorine dioxide gas source;
(ii) an absorption loop for effecting the dissolution of chlorine dioxide into a liquid stream, wherein said absorption loop is fluidly connected to said chlorine dioxide gas source; and
(iii) a gas transfer assembly interposed between said chlorine dioxide gas source and said absorption loop.

2. The on-board ship water treatment system of claim 1, wherein said chlorine dioxide gas source further comprises a single precursor chemical feed.

3. The on-board ship water treatment system of claim 1, wherein said water treatment vessel is a container for drinking water.

4. The on-board ship water treatment system of claim 1, wherein said water treatment vessel is a ballast water tank.

5. The on-board ship water treatment system of claim 1 wherein said chlorine dioxide generator is mobile skid mounted.

6. The on-board ship water treatment system of claim 1, wherein said chlorine dioxide gas source further comprises an anolyte loop and a catholyte loop, said catholyte loop fluidly connected to said anolyte loop via a common electrochemical component.

7. The on-board ship water treatment system of claim 6, wherein said anolyte loop further comprises:
(a) a reactant feedstock stream;
(b) at least one electrochemical cell fluidly connected to said feedstock stream, said electrochemical cell having a positive end and a negative end, said reactant feedstock stream directed through said electrochemical cell to produce a chlorine dioxide solution; and
(c) a stripper column, said chlorine dioxide solution directed from said positive end of said electrochemical cell into said stripper column, said stripper column producing at least one of a chlorine dioxide gas stream and excess chlorine dioxide solution, said excess chlorine dioxide solution directed out of said stripper column and recirculated with said reactant feedstock stream into said electrochemical cell, said chlorine dioxide gas stream exiting said stripper column directed to said absorption loop.

8. The on-board ship water treatment system of claim 7, wherein said reactant feedstock is a chlorite solution.

9. The on-board ship water treatment system of claim 7, wherein said reactant feedstock is a chlorate solution.

10. The on-board ship water treatment system of claim 1 further comprising a program logic control system.

11. The on-board ship water treatment system of claim 10, wherein said program logic control system monitors the concentration of chlorine dioxide in said water treatment vessel.

12. The on-board ship water treatment system of claim 10, wherein said program logic control system is capable of controlling the concentration of chlorine dioxide in said water treatment vessel.

13. The on-board ship water treatment system of claim 1, wherein said gas transfer assembly further comprises:
(a) a gas transfer pump having at least one inlet port for receiving a chlorine dioxide gas stream from said chlorine dioxide gas source and at least one outlet port for discharging a pressurized chlorine dioxide gas stream; and
(b) an exhaust manifold assembly extending from said at least one gas transfer pump outlet port, said exhaust manifold assembly comprising at least one manifold conduit defining an interior volume for directing said pressurized chlorine dioxide gas from said at least one gas transfer pump outlet port to said absorption loop, wherein said at least one manifold conduit interior volume is sufficiently large to inhibit chlorine dioxide decomposition in said pressurized chlorine dioxide gas stream.

14. The on-board ship water treatment system of claim 13, wherein said at least one manifold conduit interior volume is sufficiently large to induce a pressurized chlorine dioxide gas stream temperature within said at least one manifold conduit of less than about 163° F. (73° C.).

15. The on-board ship water treatment system of claim 13, wherein said gas transfer pump has first and second inlet ports for receiving first and second chlorine dioxide gas streams from said chlorine dioxide gas source, wherein said gas transfer pump has first and second outlet ports for discharging first and second pressurized chlorine dioxide gas streams, and wherein said discharge manifold assembly comprises first and second manifold conduits defining an aggregate conduit interior volume for directing said first and second pressurized chlorine dioxide gas streams, respectively, from said gas transfer pump to said absorption loop, wherein said aggregate manifold conduit interior volume is sufficiently large to inhibit chlorine dioxide decomposition in said pressurized chlorine dioxide gas stream.

16. The on-board ship water treatment system of claim 15, wherein said aggregate manifold conduit interior volume is sufficiently large to induce a pressurized chlorine dioxide gas stream temperature within said at least one manifold conduit of less than about 163° F. (73° C.).

17. The on-board ship water treatment system of claim 16, wherein said first and second inlet ports each has an inlet port conduit extending therefrom for receiving first and second chlorine dioxide gas streams from said chlorine dioxide gas source, wherein said first and second outlet ports each has an outlet port conduit extending therefrom for discharging first and second pressurized chlorine dioxide gas streams, and wherein said exhaust manifold assembly comprises first and second manifold conduits defining an aggregate conduit interior volume for directing said first and second pressurized chlorine dioxide gas streams, respectively, from said gas transfer pump to said absorption loop, wherein said aggregate manifold conduit interior volume is sufficiently large to inhibit chlorine dioxide decomposition in said pressurized chlorine dioxide gas stream.

18. The on-board ship water treatment system of claim 17, wherein said outlet port conduits are formed from a material having a melting point greater than about 140° F. (60° C.).

19. The on-board ship water treatment system of claim 18, wherein said outlet port conduits are formed from a material selected from the group consisting of polytetrafluoroethylene, polychlorotrifluoroethylene, chlorinated poly(vinyl chloride), titanium and other metals having a melting point greater than about 140° F. (60° C.).

20. The on-board ship water treatment system of claim 16, wherein said first and second inlet ports each has an inlet port conduit extending therefrom for receiving first and second chlorine dioxide gas streams from said chlorine dioxide gas source, wherein said first and second outlet ports each has a pair of outlet port conduits extending therefrom for discharging two pairs of pressurized chlorine dioxide gas streams, and wherein said exhaust manifold assembly comprises at least one manifold conduit defining an aggregate conduit interior volume for directing said first and second pressurized chlorine dioxide gas streams, respectively, from said gas transfer pump to said absorption loop, wherein said aggregate manifold conduit interior volume is sufficiently large to inhibit chlorine dioxide decomposition in said pressurized chlorine dioxide gas stream.

21. The on-board ship water treatment system of claim 20, wherein said outlet port conduits are formed from a material having a melting point greater than about 140° F. (60° C.).

22. The on-board ship water treatment system of claim 21, wherein said outlet port conduits are formed from a material selected from the group consisting of polytetrafluoroethylene, polychlorotrifluoroethylene, chlorinated polyvinyl chloride), titanium and other metals having a melting point greater than about 140° F. (60° C.).

23. The on-board ship water treatment system of claim 20, wherein said exhaust manifold assembly comprises a single manifold conduit defining an interior volume for directing said two pairs of pressurized chlorine dioxide gas streams from said gas transfer pump to said absorption loop, wherein said interior volume is sufficiently large to inhibit chlorine dioxide decomposition in said pressurized chlorine dioxide gas stream.

24. The on-board ship water treatment system of claim 13, wherein a ratio of the cross-sectional diameter of said at least one manifold conduit to the cross-sectional diameter of said at least one gas transfer pump outlet port is greater than 1.

25. The on-board ship water treatment system of claim 13, wherein said exhaust manifold assembly has a coolant fluid stream in thermal contact therewith, whereby said coolant fluid stream further inhibits chlorine dioxide decomposition in said pressurized chlorine dioxide gas stream.

26. The on-board ship water treatment system of claim 25, wherein said coolant fluid stream is in thermal contact with said at least one manifold conduit.

27. The on-board ship water treatment system of claim 26, wherein thermal contact of said coolant fluid stream with said at least one manifold conduit further induces a pressurized chlorine dioxide gas stream temperature within said at least one manifold conduit of less than about 163° F. (73° C.).

28. A method of treating water on-board a ship comprising:
(a) providing a source of chlorine dioxide gas;
(b) effecting the dissolution of chorine dioxide into a liquid stream by employing an absorption loop fluidly connected to said chlorine dioxide gas source;
(c) introducing said chlorine dioxide solution into a ballast water supply.

29. The method of claim 28 wherein said introduction of said chlorine dioxide solution into a ballast water supply occurs during at least one of prior to loading the ship, during the ship's voyage, and during discharge of said ballast water from the ship.

30. The method of claim 28 wherein said introduction of said chlorine dioxide solution into a ballast water supply occurs through a hydrophobic, microporous membrane to a recipient medium.

31. The method of claim 28 further comprising exposing said ballast water to intense, low frequency sonic energy.

32. The method of claim 28 further comprising introducing additional biocide into said ballast water.

33. The method of claim 28, further comprising:
(a) interposing a gas transfer pump between said chlorine dioxide gas source and said absorption loop, said gas transfer pump having at least one inlet port for receiving a chlorine dioxide gas stream from said chlorine dioxide gas source and at least one outlet port for discharging a pressurized chlorine dioxide gas stream;
(b) interposing an exhaust manifold assembly between said gas transfer pump outlet port and said absorption loop, said exhaust manifold assembly comprising at least one manifold conduit defining an interior volume for directing said pressurized chlorine dioxide gas stream from said at least one gas transfer pump outlet port to said absorption loop; and (c) inhibiting chlorine dioxide decomposition in said pressurized chlorine dioxide gas stream by effecting a volumetric increase between said at least one gas transfer pump outlet port and said at least one manifold conduit.

34. The method of claim 33 wherein said volumetric increase induces a pressurized chlorine dioxide gas stream temperature within said at least one manifold conduit of less than about 163° F. (73° C.).
